(19) United States
(12) Patent Application Publication
(10) Pub. No.: US 2017/0155986 A1
(43) Pub. Date: Jun. 1, 2017

(54) LOUDSPEAKER SYSTEM

(71) Applicant: Mahler Engineering, Halblech (DE)

(72) Inventor: Simon Mahler, Halblech (DE)

(21) Appl. No.: 15/251,335

(22) Filed: Aug. 30, 2016

(30) Foreign Application Priority Data
Nov. 30, 2015 (DE) 10 2015 120 769.9

(51) Int. Cl. H04R 1/02

(52) U.S. Cl. CPC H04R 1/025; H04R 1/026

(57) ABSTRACT

A loudspeaker system includes a loudspeaker housing comprising at least one opening for accommodating a loudspeaker, wherein a guide element and an electrical connecting element on the housing side is associated with each opening. The system includes at least one loudspeaker unit, comprising a loudspeaker and frame with a corresponding guide element and an electrical connection element on the loudspeaker side of the frame. The loudspeaker unit can be inserted into the opening, while guided by the cooperating guide elements, to a predetermined target position such that electrical contact with the loudspeaker housing is achieved suitable for operation of the loudspeaker.

### REFERENCE TO RELATED APPLICATION

This application claims priority to German Application number 10 2015 120 769.9 filed on Nov. 30, 2015, the contents of which is hereby incorporated by reference in its entirety.

### FIELD

The present invention relates to a loudspeaker system. In particular, the invention relates to a loudspeaker system, which facilitates the optimization of the sound of electronically produced and/or amplified music.

### BACKGROUND

Loudspeaker boxes, which comprise a housing and one or a plurality of loudspeakers, which are accommodated in corresponding openings in the loudspeaker housing, are used to produce electronic music or to electronically amplify music. Loudspeakers are transducers, which convert electrical signals into acoustic signals. In general, a membrane, which is typically oscillated by means of an electromagnetic alternating field, is used in a loudspeaker to convert electrical energy into sound waves. Even though different materials can be used for the membrane, membranes made of paper, are currently the most widespread alternative. In the case of a classical cone loudspeaker, a magnet is attached to the rear end of a basket. A front basket opening holds a flexible suspension of the membrane edge, which is also identified as seam, on the inside. The front basket opening furthermore serves for the installation of the loudspeaker into the loudspeaker box. Typically, a spider, which is designated to guide an oscillator coil, so that the latter moves in the air gap of a magnet in a contact-free manner, is located in the vicinity of the electromagnetic drive. Aside from their mechanical functions, these elements also contribute significantly to the sound behavior of the loudspeaker.

The sound of a loudspeaker depends quite significantly on the selection of the loudspeaker or loudspeakers, which is/are used. When searching for a desired sound ideal, loudspeaker boxes comprising different loudspeakers can thus be made available. This is the case, for example, in well-equipped sound studies, but is relatively costly, requires a large amount of space, and when changing to a different loudspeaker box, they must on principle be positioned anew. In such a case, the cabling on the rear side of amplifier and loudspeaker box must also be replugged manually.

It is generally also possible to remove loudspeakers from a loudspeaker box and to install new loudspeakers. This would be done, for example, if a loudspeaker is damaged or if the user is under the impression that the loudspeaker has suffered a loss of quality. Due to the fact that a highly diverse selection of high-quality products from well-known manufacturers is available in particular in the field of loudspeakers, which are designated specifically for the reproduction of directly amplified instrument signals of guitars, for example, it is a significant challenge to find the loudspeaker model, which best matches a certain sound need. Due to the fact that every loudspeaker has its own sound character, this can often also be the motivation for changing or switching to a different loudspeaker. However, the exchange of a loudspeaker is laborious and time-consuming and, can, usually, only be carried out by a technician, but not by the musician himself. In addition, the exchange of loudspeakers, if it is made at all, is so lengthy that the musician cannot make a true comparison of the situation prior and after the exchange, because he may no longer be aware of the sound impression prior to the conversion. For comparison purposes, the musician would need to instead use sound recordings. Currently, the exchange of loudspeakers for the purpose of optimizing the sound is unrealistic and unpractical in this regard, and is more likely the object of repair or updating of the loudspeaker box.

### SUMMARY

The problem underlying the invention is to provide a loudspeaker system, which makes it possible for the user, specifically the performer of electronic or electronically amplified music, to optimize the sound of the loudspeaker system. This problem is solved by means of a loudspeaker system according to claim 1. Advantageous further developments are specified in the dependent claims.

The loudspeaker system of the invention comprises a loudspeaker housing comprising at least one, preferably two openings, for accommodating a respective corresponding loudspeaker, wherein at least one guide element on the housing side is associated with each opening, and at least one electrical connecting element on the housing side is associated with each opening. The loudspeaker system further comprises at least one, preferably two loudspeaker units, wherein the at least one loudspeaker unit comprises a loudspeaker, which can be inserted into said opening, at least one guide element on the loudspeaker side, which cooperates with a corresponding guide element on the housing side in such a way that the loudspeaker is guided into a predetermined target position upon insertion into the opening in the loudspeaker housing, and at least one electrical connecting element on the loudspeaker side.

Finally, the loudspeaker system comprises a catch or locking mechanism, by means of which the loudspeaker unit can engage or be locked in said target position. The electrical connecting element on the housing side is thereby arranged in such a way with respect to the guide element on the housing side, and the electrical connecting element on the loudspeaker side is arranged in such a way with respect to the guide element on the loudspeaker side that the electrical connecting element on the loudspeaker side and on the housing side can be brought into an electrical contact upon the insertion of the loudspeaker into the corresponding opening in the loudspeaker housing while guided by the cooperating guide elements, and that an electrical contact, which is suitable for the operation of the loudspeaker, is obtained, when the loudspeaker assumes the mentioned predetermined target position.

It is thus possible with the loudspeaker system of the invention to insert different loudspeakers into the loudspeaker housing as part of a loudspeaker unit according to the invention comprising a guide element on the loudspeaker side and an electrical connecting element on the loudspeaker side, and to thereby establish a mechanical connection as well as the electrical connection. It is thus made possible for the user to insert different loudspeakers into the loudspeaker housing consecutively and to thus optimize the sound. The insertion and automatic electrical connection of the respective loudspeakers works so easily and quickly that the user still “hears” the sound of the respective previous loudspeaker, when he is ready to conduct the sound test with the next loudspeaker. The user, thus typically the artist himself or the sound engineer, can thus optimize the sound by selecting the loudspeaker. The invention is based on the knowledge, among others, that “an ideal sound” of a loudspeaker system does not exist, but that, depending on the respective piece, the acoustic conditions in the studio or in the concert hall and the like, different loudspeaker configurations will exist, which lead to the desired result. The loudspeaker system of the invention enables the artist or the sound engineer to find and convert this optimal result by trial and error.

In a preferred embodiment, for the same opening in the loudspeaker housing a plurality of exchangeable loudspeaker units comprising different loudspeakers is provided. The user can then select that loudspeaker unit from these loudspeaker units comprising different loudspeakers, which best meets his sound expectations

Preferably, one of the electrical connecting element on the housing side and the electrical connecting element on the loudspeaker side is formed by a plug, in particular a jack plug, and the other one is formed by a socket, in particular a jack socket. A good, reproducible and secure electrical connection is established by plug and socket. As will be explained in more detail below by means of an exemplary embodiment, a guide, by means of which the connection of plug and socket can be established reliably in an automatic manner upon the insertion, can be attained by means of suitable guide elements on the housing side and on the loudspeaker side.

Said catch or locking mechanism serves the purpose of fixing the loudspeaker unit in the inserted position, that is, to establish a sufficiently reliable mechanical connection. The catch or locking mechanism is thereby preferably designed to pull or to bias the loudspeaker unit in the mentioned target position against the loudspeaker housing. For this purpose, the locking mechanism can comprise at least one, preferably two turning-switch latches, for example. A close contact between the loudspeaker unit on the one hand and the housing on the other hand has an advantageous effect on the sound. On the side facing the loudspeaker housing, the loudspeaker unit preferably comprises a seal. The opening in the loudspeaker housing can thus be closed in an at least approximately pressure-tight manner, which also has an advantageous effect on the sound.

In a preferred embodiment, the at least one guide element on the loudspeaker side is formed by a guide pin and the corresponding guide element on the housing side is formed by a socket for accommodating the guide pin, in particular a socket comprising a linear ball bearing. As will be shown in detail below with reference to an exemplary embodiment, a highly precise guide, which also provides for a simple and comprehensible operation, can be obtained with comparatively simple means as a result of the combination of a guide pin with a corresponding socket. In practice, the use of a linear ball bearing has proven to be particularly advantageous, because it combines a guide, which is virtually free from play and thus precise, with a comparatively low frictional resistance upon the insertion of the loudspeaker.

Preferably, the loudspeaker unit has a removable and/or exchangeable lining, wherein the lining is to be removably fastened to the loudspeaker unit by means of a catch or locking mechanism. The exchangeable lining thereby preferably comprises a frame, on which at least one, preferably two handles, in particular finger loops, are provided, on which the lining can be held when it is attached to or removed from the loudspeaker unit. Preferably, different linings are provided, which can selectively be combined with the same loudspeaker unit. These embodiments are based on the knowledge that the lining, which is typically provided to protect a loudspeaker, also impacts the sound. It can be determined, for example, that certain linings reflect certain frequencies more than others, and thus lead to an influencing of the sound pattern. According to this embodiment of the invention, it is easily possible to either omit the lining or to choose that lining among different linings, which are in stock, which leads to the desired sound pattern. It is again highly advantageous in this context that the lining can be removed or exchanged in a simple manner, so that the optimization of the sound can be based on the immediate auditory impression.

In a preferred embodiment, the loudspeaker unit comprises at least one, preferably two handles, on which the loudspeaker unit can be held upon the insertion of the loudspeaker into the opening in the loudspeaker housing. The handling of the loudspeaker unit upon the insertion into or the removal from the loudspeaker housing is thus facilitated. Preferably, the at least one handle is embodied so as to be curved. In addition or in the alternative, the at least one handle—in the inserted state—protrudes by at least 3 cm from the side of the loudspeaker unit facing away from the housing. The at least one handle thus provides additional protection for the loudspeaker.

In a particularly preferred embodiment, the loudspeaker unit comprises a frame, to which different commercial loudspeakers can be fastened, and on which the loudspeaker side guide element and the loudspeaker side electrical connecting element are provided. The frame can thereby comprise a plurality of groups of holes, wherein the holes are arranged in such a way in each group of holes that they make it possible to accommodate screws for the assembly of certain, commercial loudspeakers. These groups of holes can be offset from one another in circumferential direction, for example. Different commercial loudspeakers can thus be combined with an identically constructed frame, so as to form corresponding loudspeaker units.

Preferably, the frame of the loudspeaker unit consists of metal, in particular of aluminum.

In an advantageous further development, the loudspeaker housing has at least two openings for accommodating loudspeakers, wherein the loudspeaker system comprises a first socket, in particular a jack socket, for connecting a mono signal, which is simultaneously applied to at least two loudspeakers, and comprises at least a second socket, in particular a jack socket, preferably a number of second (jack) sockets, which corresponds to the number of loudspeaker openings, for connecting a respective signal to only one corresponding loudspeaker.

Herein, at least some of the (jack) sockets preferably have a switching function such that the position of at least one assigned switch changes automatically when plugging in a plug. The respective associated switches furthermore preferably cooperate with the electrical connecting elements on the housing side such that
all of the loudspeakers are connected in series, if a (jack) plug is plugged into the first (jack) socket, and no (jack) plug is plugged into one of the second (jack) sockets, and
the loudspeakers are not connected in series, if at least one (jack) plug is plugged into one of the second (jack) sockets.

According to this embodiment, the loudspeaker system can accordingly be used in common mono operation, wherein a mono signal is fed into the first jack socket, and all of the loudspeakers are connected in series. If the loudspeaker system includes two 8-Ohm loudspeakers, for example, the 16-Ohm output of an amplifier can be connected to the first jack socket. In the alternative, however, it is also possible to apply two different signals to the two second jack sockets. The two loudspeakers are then not connected in series in this case.

According to the preferred embodiment, no switch needs to be operated manually for this purpose, but the corresponding switching is effected automatically by means of the switch function of the jack sockets. In this case, the different signals would be signals from an 8-Ohm output of an amplifier, for example. It is also possible to apply only one signal to one of the second jack sockets and to thus only operate one of the loudspeakers actively. The other loudspeaker could then resonate passively. In a further alternative, the other loudspeaker unit as a whole could be removed from the housing, so that the loudspeaker housing is open at one location on the front side. Further possibilities for designing the sound result in this way.

In a preferred embodiment, the loudspeaker housing consists of natural stone or of glass, but can also consist of concrete, acrylic or wood. Both natural stone as well as glass have the advantage that they do are not made to oscillate or are made to oscillate only slightly by the loudspeakers, and thus do not interfere with the loudspeaker sound in an uncontrolled manner. This leads to an extremely precise sound, which is almost exclusively determined by the behavior of the loudspeakers, whereby the design of the sound according to the invention becomes particularly effective by the selection of loudspeakers.

In the case of a housing made of natural stone or glass, it is not easy to fasten components, such as, for example, the housing side guide element or the housing side electrical connecting element, to the loudspeaker housing. As a particularly suitable measure for this, the element or a holding section connected thereto can be glued into a hole in the loudspeaker housing, preferably with the help of an epoxy resin.

In a preferred embodiment, the loudspeaker system has a front side, on which the at least one opening for the at least one loudspeaker is provided, and a rear side, which is located opposite the front side, wherein at least one closable opening is provided on the rear side. Depending on whether this opening is open or closed, a further characteristic change of the sound results. In the case of a closed opening, the sound is typically more precise and more defined, in particular in the bass range, because the enclosed air counteracts the movement of the membrane, and because this results in a controlled movement of the membrane. Instead, the advantage that the membrane can cover a larger distance and can thus move more air mass, results in the open state. The open state thus appears to be louder, in particular in the bass range. The closed configuration thus has a clearer bass reproduction, but is quieter and has less bass than the open configuration. Due to this closable opening, the sound can further be designed according to the ideas of the artist or sound engineer. In a particularly advantageous embodiment, the number of the openings on the rear side corresponds to the number of the loudspeaker openings on the front side. This makes it possible to operate individual loudspeakers “with open rear wall”, and to simultaneously operate other loudspeakers “with closed rear wall”. An intermediate state “semi-open rear wall” can be established in this way, in that only the closure of one of the openings of the rear wall is removed. This also provides for further novel sound patterns.

Preferably, the at least one opening on the rear can be closed in an air-tight or approximately air-tight manner. When the opening is closed, a difference in the pressure can thus form between the interior and the exterior of the housing, which is characteristic for the operation of closed loudspeaker boxes. Preferably, the at least one opening on the rear side is circular, and provision is made for a cover, which is also circular and which can be inserted into the opening and be closed by turning same.

### BRIEF DESCRIPTION OF THE DRAWINGS

FIG. 1 shows a perspective view of a loudspeaker system comprising two loudspeaker units.

FIG. 2 shows a front view of the loudspeaker system of FIG. 1.

FIG. 3 shows a perspective rear view of the loudspeaker system of FIG. 1.

FIG. 4 shows a perspective view of the loudspeaker housing of FIG. 1.

FIG. 5 shows a front view of the loudspeaker housing of FIG. 1.

FIG. 6 shows a perspective rear view of the loudspeaker housing of FIG. 1.

FIG. 7 shows a perspective view of the loudspeaker system of FIG. 1 upon the insertion of a loudspeaker unit.

FIG. 8 also shows a perspective view of the loudspeaker system of FIG. 1 upon the insertion of a loudspeaker unit.

FIG. 9 shows a side view of the loudspeaker system of FIG. 1 upon the insertion of a loudspeaker unit.

### DETAILED DESCRIPTION

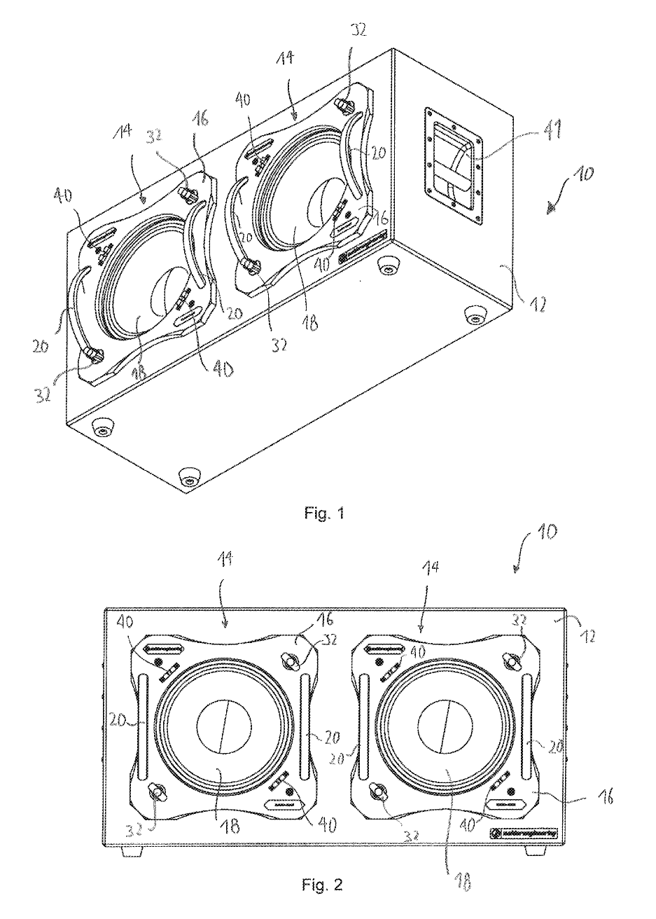

FIG. 1 shows a perspective view of a loudspeaker system 10 according to an embodiment of the invention. The loudspeaker system 10 comprises a housing 12, which, in the shown exemplary embodiment, consists of natural stone, and two loudspeaker units 14.

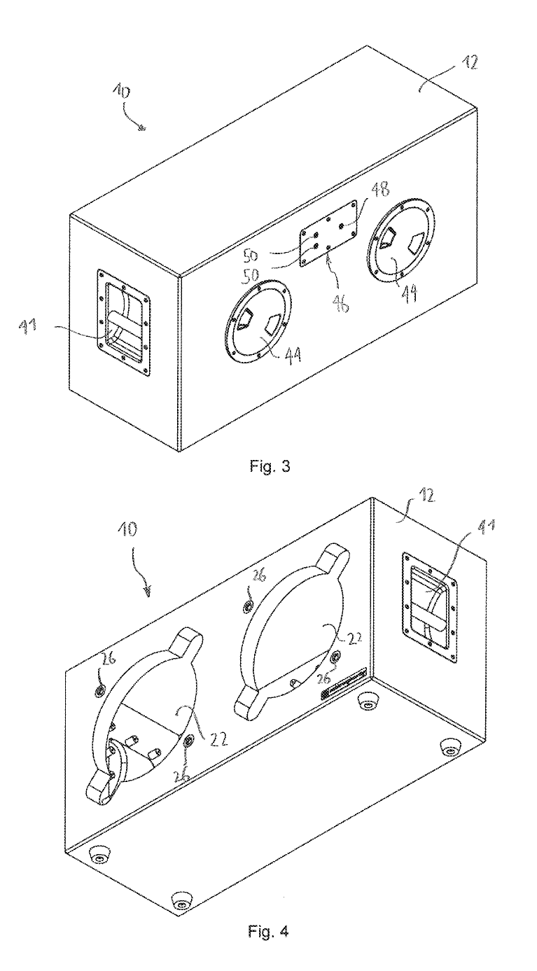

FIG. 2 shows a front view of the loudspeaker system 10 of FIG. 1.

FIG. 3 shows a perspective rear view of the loudspeaker system 10 of FIG. 1.

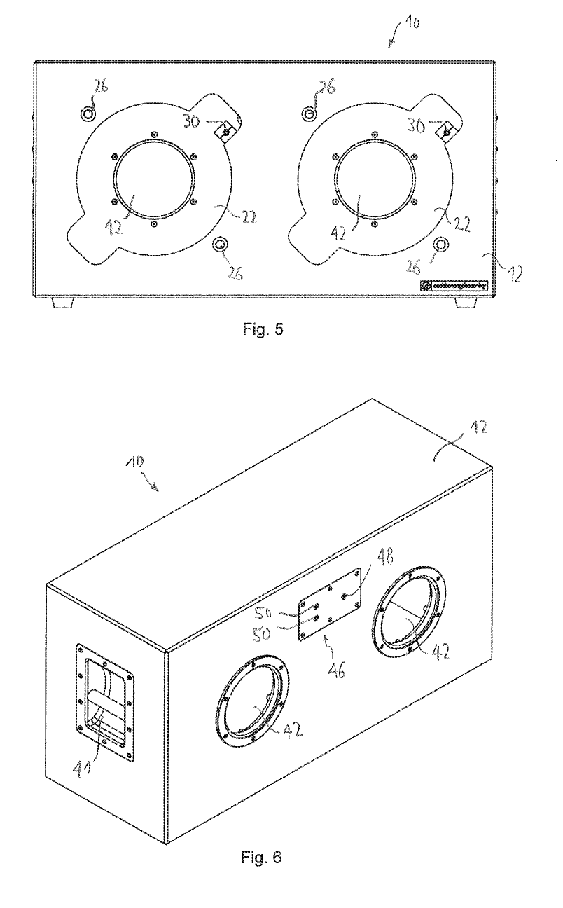

FIGS. 4 to 6 show the same views as FIGS. 1 to 3, in which, however, the loudspeaker units 14 are omitted.

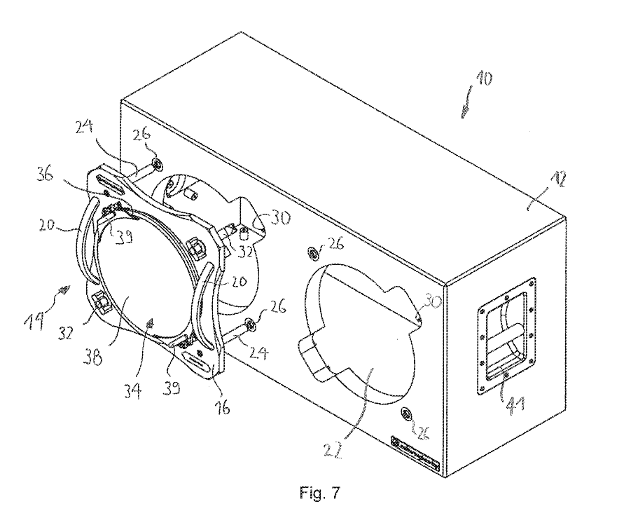

FIGS. 7 to 9 show two perspective views and a side view of the same system 10 of FIGS. 1 to 6, in which, however, a loudspeaker unit 14 is omitted, and in which a further loudspeaker unit 14 for insertion into the loudspeaker housing 12 is arranged.

As can be seen in FIG. 1, for example, each loudspeaker unit 14 comprises a frame 16, to which a commercially available loudspeaker 18 is fastened. In the shown embodiment, the frame 16 is made of aluminum. Two curved handles 20, on which the loudspeaker unit 14 can be held when it is inserted into the housing 12, are arranged on the frame 16, as is shown in FIGS. 7 to 9.

The housing 12 has two openings 22, which can be seen well in FIG. 4, for example. The openings 22 are designated to accommodate a corresponding loudspeaker 18. Two guide pins 24, which can be seen in FIGS. 7 to 9, extend from the rear side of the frame 16 of the loudspeaker unit 14. In the shown embodiment, the guide pins 24 are made of tool steel. The guide pins 24 are an example of the above-mentioned guide elements on the loudspeaker side. The guide pins 24 are designated for insertion into corresponding sockets 26 on the loudspeaker housing 12. In the shown exemplary embodiment, the sockets 26 comprise a linear ball bearing (not shown). The sockets 26 are glued into corresponding holes in the housing 12 by means of epoxy resin. The sockets 26 are an example for the above-mentioned guide elements on the housing side.

As can further be seen in FIG. 9, a jack socket 28 is further arranged on the rear side of the frame 16. The jack socket 28 is an example for the above-mentioned electrical connecting element on the loudspeaker side. Provision is made in the loudspeaker housing 12 for a jack plug 30 in each of the openings 22 (see FIG. 5). The jack plug 30 is an example for the above-mentioned electrical connecting element on the housing side.

Finally, each loudspeaker unit 14 comprises two turning-switch latches 32.

The mode of operation of the loudspeaker system 10 will be described next. A characteristic of the loudspeaker system 10 according to the invention is that the loudspeaker units 14 can be inserted into the loudspeaker housing 12 in a simple manner, can be fastened mechanically therein and can simultaneously be connected electrically. The user, for example a musician or a sound engineer, is thus enabled to insert loudspeaker units 14 comprising an identical frame 16, but different loudspeakers 14, into the loudspeaker housing 12 in an optional manner, so as to thus optimize the sound of the loudspeaker system. Even though they are not shown, the system according to the invention is provided with more loudspeaker units 14 than there are openings in the loudspeaker housing 12, from which the user then chooses so as to optimize the sound. The exchange of the loudspeaker units 14 thereby occurs so easily and quickly that the user still “hears” the sound of the previous loudspeaker constellation, when he tries out the next loudspeaker constellation, which facilitates the search for the ideal sound significantly.

To insert a loudspeaker unit 14, the user seizes the loudspeaker unit 14 on the handles 20 and inserts the guide pins 24 into the corresponding guide sockets 26, as is shown in FIGS. 7 to 9. Herein, the guide pins 24 in the sockets 26 have an extremely small play, so that the guide is very accurate. Due to the linear ball bearings (not shown) in the sockets 26, the guide pins 24 can nonetheless be inserted into the sockets 26 with a relatively small resistance.

The relative arrangement of the sockets 26 with respect to the jack plug 30 on the one hand and the relative arrangement of the guide pins 24 with respect to the jack socket 28 on the other hand ensures that the jack plug 30 is inserted automatically into the jack socket 28 upon the insertion of the loudspeaker unit 14 into the loudspeaker housing 12—by guiding through the guide pins 24 and the sockets 26—whereby the loudspeaker 18 is connected electrically. When the loudspeaker unit 14 is inserted completely into the loudspeaker housing 12, the turning-switch latches 32 are turned and are thus brought into a locked position. The position of the turning-switch latch 32 shown in FIGS. 7 to 9 on the side of the frame 16 facing the loudspeaker housing 12 shows the end position in the locked state. This is shown for illustration purposes. In practice, loudspeaker units 14 in the removed state will mostly have the switch latch position “open”, wherein the switch latch is turned by 90° as compared to FIGS. 7 to 9, so that it can be inserted completely into the opening for loudspeaker 18 of the loudspeaker housing 12. When the turning-switch latch 32 is brought into locked position, the switch latch undercuts the front side of the loudspeaker housing 12 on the side of the turning-switch latch 32 facing the loudspeaker housing 12. Upon being turned into locked position, the loudspeaker unit 14 is pulled or biased against the front side of the loudspeaker housing 12. On the rear side of the loudspeaker unit 14, that is, on the side facing the front side of the loudspeaker housing 12, provision is made for a seal (not shown), so that the loudspeaker unit 14 closes the opening 22 in the loudspeaker housing 12 in an at least approximately pressure-tight manner.

A lining 34, which covers the loudspeaker 18, is further shown in FIGS. 7 to 9. Such a lining is not shown in FIGS. 1 to 3. The lining 34 comprises frame 36, which holds a fabric 38, and which has finger loops 39 for seizing the frame 36. Provision is made on the side of the frame 36 facing the loudspeaker housing 12 for catch means (not shown), which can engage with corresponding recesses 40 (see FIGS. 1 and 2) on the frame 16 of the loudspeaker unit 14. The lining 34 can thus be attached easily to the frame 16 of the loudspeaker unit 14 and can be fastened by engagement. This makes it possible, for example, to operate the loudspeaker 18 either with or without lining 34, which also influences the sound. It is possible, in particular, to fasten the lining 34 to the loudspeaker unit 14 by default, so as to protect the loudspeaker 18 from dust, dirt or other external influences and to only remove it, when the loudspeaker system 10 is used and a corresponding sound is desired. However, the lining 34 can also be beneficial for some desired sound patterns. Similar to the loudspeakers 18, different linings 34 comprising different acoustic characteristics can be stored as well and can selectively be attached to the loudspeaker unit 14, so as to further optimize the sound.

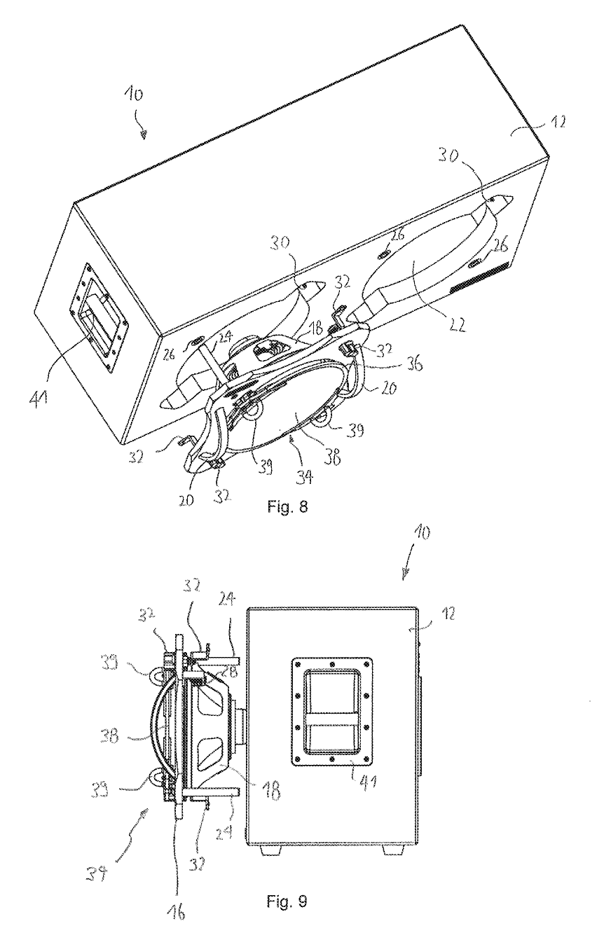

As can furthermore be gathered from FIGS. 1 and 8, for example, the loudspeaker housing 12 has an integrated carry handle 41 in both side walls.

FIGS. 3 and 6 show perspective rear views of the loudspeaker housing 12. Two circular openings 42 (see FIG. 6), which can be closed by means of corresponding circular covers 44, which are shown in FIG. 3, are located in the rear wall of the loudspeaker housing 12. The covers 44 can thereby be brought into a locked position, in which the cover 44 closes the opening 42 in an at least approximately pressure-tight manner, by means of turning. The sound of the loudspeaker system 10 changes, depending on whether the opening 42 is open (see FIG. 6) or closed by the cover 44 (see FIG. 3). As has been explained in the introductory part of the description, a bass-heavy, voluminous sound follows without cover 44. In contrast, a more subtle, more precise sound results when covers 44 are closed. On the rear side of the loudspeaker housing 12, the openings 42, which can be closed by means of the covers 44, thus provide further options to the user for influencing the sound of the loudspeaker system 10.

The loudspeaker system 10 in this embodiment comprising two openings 22 for loudspeakers 18 can be generally connected to the amplifier in two different operating modes. The connections for this are located on a connection terminal 46, which can be seen in FIGS. 3 and 6. The first operating mode represents the mono operation, wherein only one connection 48 may be used for the mono operation. In the mono operation, both loudspeakers 18 are connected in series, it is thus imperative that all openings 22 for loudspeakers 18 be equipped with a loudspeaker unit 14 in the mono operation, so as to close the electric circuit. In the stereo operation, only connections 50 are used for the stereo operation. They are independent from one another. It is thus also possible to only use one loudspeaker unit 14, and operate it with the corresponding connection 50 assigned thereto. These operating modes are made possible by the specific interconnection of switchable jack connecting sockets 48 and 50.

A special and highly uncommon sound effect can be obtained in that only one loudspeaker unit 14 is used, as is shown in FIGS. 7 to 9, and the other loudspeaker opening 22 remains free. In this case, the loudspeaker system is operated in the stereo mode, but only with one inserted loudspeaker unit 14. In the case of common loudspeaker boxes, it is not possible to omit a loudspeaker 18, as proposed here, without interconnecting the entire cabling anew. It is pointed out that the explained exemplary embodiments are to be considered as merely being examples and as not limiting the invention. It is pointed out in particular that the described features and embodiments can be significant in any combination and that the different possibilities can be combined with one another arbitrarily.

### LIST OF REFERENCE NUMERALS

10 loudspeaker system
12 loudspeaker housing
14 loudspeaker unit
16 frame of the loudspeaker unit 14
18 loudspeaker
20 handle
22 opening for loudspeaker 18
24 guide pin
26 socket
28 jack socket
30 jack plug
32 turning-switch latch
34 lining
36 frame of the lining 34
38 fabric of the lining 34
39 finger loop
40 accommodation for catch means lining 34
41 carry handle
42 opening on housing rear side
44 cover for closing the opening 42
46 connection terminal
48 connection mono operation
50 connections stereo operation

What is claimed is:

1. A loudspeaker system, which comprises the following:
a loudspeaker housing comprising at least one, preferably two, openings for accommodating a respective corresponding loudspeaker, wherein at least one guide element on the housing side is associated with each opening, and at least one electrical connecting element on the housing side is associated with each opening,
at least one, preferably two loudspeaker units, wherein the at least one loudspeaker unit comprises the following:
a loudspeaker, which can be inserted into said opening,
at least one guide element on the loudspeaker side, which cooperates with a corresponding guide element on the housing side in such a way that the loudspeaker is guided into a predetermined target position upon insertion into the opening in the loudspeaker housing, and
at least one electrical connecting element on the loudspeaker side, and
a catch or locking mechanism, by means of which the loudspeaker unit can engage or be locked in said target position,
wherein the electrical connecting element on the housing side is arranged in such a way with respect to the at least one guide element on the housing side, and the electrical connecting element on the loudspeaker side is arranged in such a way with respect to the at least one guide element on the loudspeaker side that the electrical connecting element on the loudspeaker side and on the housing side are brought into an electrical contact in response to the insertion of the loudspeaker into the corresponding opening in the loudspeaker housing while guided by the cooperating guide elements, and that an electrical contact, which is suitable for the operation of the loudspeaker, is obtained, when the loudspeaker assumes the mentioned predetermined target position.

2. The loudspeaker system according to claim 1, wherein for the same opening in the loudspeaker housing, a plurality of exchangeable loudspeaker units comprising different loudspeakers is provided.

3. The loudspeaker system according to claim 1, wherein one of the electrical connecting element on the housing side and the electrical connecting element on the loudspeaker side is formed by a plug, in particular a jack plug, and the other is formed by a socket, in particular a jack socket.

4. The loudspeaker system according to claim 1, wherein the catch or locking mechanism is designed to pull or bias the loudspeaker unit in the mentioned target position against the loudspeaker housing.

5. The loudspeaker system according to claim 4, wherein the locking mechanism comprises at least one, preferably two turning-switch latches.

6. The loudspeaker system according to claim 1, wherein the loudspeaker unit comprises a seal on the side facing the loudspeaker housing.

7. The loudspeaker system according to claim 1, wherein the at least one guide element on the loudspeaker side is formed by a guide pin and the at least one guide element on the housing side is formed by a socket for accommodating the guide pin, in particular a socket comprising a linear ball bearing.

8. The loudspeaker system according to claim 1, wherein the loudspeaker unit has a removable and/or exchangeable lining, wherein the lining is to be removably fastened to the loudspeaker unit by means of a catch or locking mechanism.

9. The loudspeaker system according to claim 8, wherein the exchangeable lining comprises a frame, on which at least one, preferably two handles, in particular finger loops, are provided, by which the lining can be held when it is attached to or removed from the loudspeaker unit.

10. The loudspeaker system according to claim 8, wherein different linings are provided, which can selectively be combined with the same loudspeaker unit.

11. The loudspeaker system according to claim 1, wherein the loudspeaker unit comprises at least one, preferably two handles, by which the loudspeaker unit can be held when inserting the loudspeaker into the opening in the loudspeaker housing.

12. The loudspeaker system according to claim 11, wherein the at least one handle is embodied so as to be curved and/or—in the inserted state—protrudes by at least 3 cm from the side of the loudspeaker unit facing away from the housing.

13. The loudspeaker system according to claim 1, wherein the loudspeaker unit comprises a frame to which different commercially available loudspeakers can be fastened, and on which the guide element on the loudspeaker side and the electrical connecting element on the loudspeaker side are provided.

14. The loudspeaker system according to claim 13, wherein the frame comprises a plurality of groups of holes, wherein the holes in each group of holes are arranged such as to permit to receive screws for mounting predetermined commercially available loudspeakers.

15. The loudspeaker system according to claim 13, wherein the frame of the loudspeaker unit consists of metal, in particular of aluminum.

16. The loudspeaker system according to claim 1, wherein the loudspeaker housing has at least two openings for accommodating loudspeakers, wherein
the loudspeaker system comprises a first socket for connecting a mono signal, which is simultaneously applied to at least two loudspeakers, and
the loudspeaker system comprises at least a second socket, preferably a number of second sockets, which corresponds to the number of loudspeaker openings, for connecting a respective signal to only one corresponding loudspeaker,
wherein preferably at least some of the sockets have a switching function such that the position of at least one associated switch changes automatically when plugging in a plug, and the respective associated switches cooperate with the electrical connecting elements on the housing side such that
all of the loudspeakers are connected in series, if a plug is plugged into the first socket, and no plug is plugged into any of the second sockets, and
the loudspeakers are not connected in series, if at least one plug is plugged into at least one second socket.

17. The loudspeaker system according to claim 1, wherein the loudspeaker housing consists of natural stone, glass, concrete, acrylic or wood.

18. The loudspeaker system according to claim 17, wherein the guide element on the housing side and/or the electrical connecting element on the housing side is fastened to the loudspeaker housing, in that the corresponding element or a holding section connected thereto is glued into a hole in the loudspeaker housing, in particular with the help of an epoxy resin.

19. The loudspeaker system according to claim 1, wherein the loudspeaker housing has a front side, on which the at least one opening for the at least one loudspeaker is provided, and a rear side, which is located opposite the front side, wherein at least one closable opening is provided on the rear side.

20. The loudspeaker system according to claim 19, wherein the number of the openings on the rear side corresponds to the number of the loudspeaker openings on the front side.

21. The loudspeaker system according to claim 19, wherein the at least one opening on the rear side can be closed in an air-tight or approximately air-tight manner.

22. The loudspeaker system according to claim 19, wherein the at least one opening on the rear side is circular, and a cover is provided, which is also circular and which can be inserted into the opening and be closed by turning the same.
